(19) United States
(12) Patent Application Publication
(10) Pub. No.: US 2015/0129805 A1
(43) Pub. Date: May 14, 2015

(54) METHOD FOR PRODUCING CO AND/OR H2 IN AN ALTERNATING OPERATION BETWEEN TWO OPERATING MODES

(71) Applicant: Bayer Intellectual Property GmbH, Monheim (DE)

(72) Inventors: Alexander Karpenko, Leverkusen (DE); Kristian Voelskow, Koln (DE); Emanuel Kockrick, Dusseldorf (DE); Albert Tulke, Langenfeld (DE); Daniel Gordon Duff, Leverkusen (DE); Stefanie Eiden, Leverkusen (DE); Oliver Felix-Karl Schlüter, Leverkusen (DE); Vanessa Gepert, Wuppertal (DE); Ulrich Nieken, Stuttgart (DE); René Kelling, Stuttgart (DE)

(21) Appl. No.: 14/384,460

(22) PCT Filed: Mar. 12, 2013
(86) PCT No.: PCT/EP2013/055010

§ 371 Date: Sep. 11, 2014

(30) Foreign Application Priority Data
Mar. 13, 2012 (DE) 10 2012 203 911.2
Mar. 13, 2012 (DE) 10 2012 203 912.0
Mar. 13, 2012 (DE) 10 2012 203 913.9
Mar. 13, 2012 (DE) 10 2012 203 914.7
Mar. 13, 2012 (DE) 10 2012 203 915.5
Mar. 13, 2012 (DE) 10 2012 203 917.1
Mar. 13, 2012 (DE) 10 2012 203 919.8
Mar. 13, 2012 (DE) 10 2012 203 920.1
Mar. 13, 2012 (DE) 10 2012 203 922.8
Mar. 13, 2012 (DE) 10 2012 203 923.6
Mar. 13, 2012 (DE) 10 2012 203 925.2
Mar. 13, 2012 (DE) 10 2012 203 926.0

(51) Int. Cl. C01B 3/38

(52) U.S. Cl. CPC C01B 3/384; C01B 2203/0238; C01B 2203/0866; C01B 2203/1088
USPC 252/373

(57) ABSTRACT

The invention relates to a method for producing syngas in an alternating operation between two operating modes. The method has the steps of providing a flow reactor; endothermically reacting carbon dioxide with hydrocarbons, water, and/or hydrogen in the flow reactor, at least carbon monoxide being formed as the product, under the effect of heat generated electrically by one or more heating elements (110, 111, 112, 113); and at the same time exothermically reacting hydrocarbons, carbon monoxide, and/or hydrogen as reactants in the flow reactor. The exothermic reaction releases a heat quantity Q1, the electric heating of the reactor releases a heat quantity Q2, and the exothermic reaction and the electric heating of the reactor are operated such that the sum of Q1 and Q2 is greater than or equal to the heat quantity Q3 which is required for an equilibrium yield Y of the endothermic reaction of ≧90%.

The present invention relates to a process for preparing synthesis gas involving the interplay of an endothermic reaction, electrical heating and an exothermic reaction.

The increased development of renewable energies is causing a fluctuating energy supply on the power grid. In periods of favorable power prices, for the operation of reactors for performance of endothermic reactions, preferably for the preparation of synthesis gas, there is the possibility of efficient and economically viable operation exploiting renewable energies when these reactors are heated electrically.

In periods in which no renewable electrical energy is available, it is then necessary to choose another form of power supply to the endothermic reactions.

Conventionally, synthesis gas is prepared by means of the steam reforming of methane. Because of the high heat requirement of the reactions involved, they are performed in externally heated reformer tubes. Characteristic features of this process are limitation by the reaction equilibrium, a heat transport limitation, and in particular the pressure and temperature limitation of the reformer tubes used (nickel-based steels). In terms of temperature and pressure, this results in a limitation to a maximum of 900° C. at about 20 to 40 bar.

An alternative process is autothermal reforming. In this case, a portion of the fuel is combusted by addition of oxygen within the reformer, such that the reaction gas is heated and the endothermic reactions that proceed are supplied with heat.

In the prior art, some proposals have become known for internal heating of chemical reactors. For example, Zhang et al., International Journal of Hydrogen Energy 2007, 32, 3870-3879 describe the simulation and experimental analysis of a coaxial, cylindrical methane steam reformer using an electrically heated alumite catalyst (EHAC).

With regard to alternating operation, DE 10 2007 022 723 A1/US 2010/0305221 describes a process for preparing and converting synthesis gas, which is characterized in that it has a plurality of different operating states consisting essentially of mutually alternating (i) daytime operation and (ii) nighttime operation, wherein daytime operation (i) comprises principally dry reforming and steam reforming with a supply of renewable energy, and nighttime operation (ii) comprises principally the partial oxidation of hydrocarbons, and the synthesis gas prepared is used to produce products of value.

US 2007/003478 A1 discloses the preparation of synthesis gas with a combination of steam reforming and oxidation chemistry. The process involves the use of solids in order to heat up the hydrocarbon feed and to cool down the gaseous product. According to this publication, heat can be conserved by reversing the gas flow of feed and product gases at intermittent intervals.

WO 2007/042279 A1 concerns a reformer system comprising a reformer for chemically converting a hydrocarbon-containing fuel to a hydrogen-gas-rich reformate gas, and electric heating devices by which thermal energy for generating a reaction temperature required for the conversion is fed to the reformer; and a capacitor which supplies the electric heating devices with electric current.

WO 2004/071947 A2/US 2006/0207178 A1 relates to a hydrogen production system comprising a reformer for producing hydrogen from a hydrocarbon fuel, a compressor for compressing the hydrogen produced, a renewable energy source for converting a renewable resource into electricity for powering the compressor and a storage device for storing the compressed hydrogen from the compressor.

It becomes clear from the above statements that an economically viable preparation of synthesis gas exploiting renewable energy sources makes certain demands on the process procedure and the reactor used therein. On the one hand, efficient electrical heating of the reactor, i.e. efficient power supply to the endothermic reactions, has to be achieved. On the other hand, there has to be the option of heating the reactor in another way for periods in which no renewable energy is utilizable.

It is an object of the present invention to provide such a process. More particularly, the object is to specify a process for preparing synthesis gas which is suitable for alternating operation between two different modes of operation.

This is achieved in accordance with the invention by a process for preparing gas mixtures comprising carbon monoxide and hydrogen, comprising the steps of:
providing a flow reactor set up for reaction of a fluid comprising reactants,
   where the reactor comprises at least one heating level which is electrically heated by means of one or more heating elements,
   where the fluid can flow through the heating level and
   where a catalyst is arranged on at least one heating element and can be heated thereon;
endothermic reaction of carbon dioxide with hydrocarbons, water and/or hydrogen in the flow reactor, forming at least carbon monoxide as product, with electrical heating by one or more heating elements; and simultaneously
exothermic reaction of hydrocarbons, carbon monoxide and/or hydrogen as reactants in the flow reactor;
   wherein the exothermic reaction releases an amount of heat Q1, the electrical heating of the reactor releases an amount of heat Q2 and the exothermic reaction and the electrical heating of the reactor are operated such that the sum total of Q1 and Q2 is greater than or equal to the amount of heat Q3 required for an equilibrium yield Y of the endothermic reaction of ≧90%.

In the process of the invention, various amounts of heat are considered and compared to one another. If necessary, they can be referenced, for example, to time or to the amount of material reacting in the reactor. The amount of heat Q1 is released in the exothermic reaction and in this way contributes to the heating of the reactants.

The amount of heat Q2 is the amount of heat which is released by the electrical heating of the reactor. More particularly, it is the amount of heat which increases the temperature of the reactants present in the reactor.

The amount of heat Q3 is calculated. Suitable methods for this purpose are the methods which are sufficiently well-known in the field of chemical engineering. For this purpose, the endothermic reaction of CO₂ with the other reactants is considered in the composition present in the reactor. The amount of heat Q3 needed for an equilibrium yield Y of ≧90% is derived therefrom.

The expression “equilibrium yield Y of the endothermic reaction of 90%” should be understood such that 90% of the maximum achievable yield in thermodynamic terms is achieved under the given conditions. For example, a reaction in the reactor may achieve a yield, based on the carbon dioxide used, of 58% due to thermodynamic limitations. 90% of 58% would correspond to 52.2%, which is used as the basis for the demand for heat Q3.

By controlling the proportions of electrical heating and exothermic reaction, it is then ensured that the sum of Q1 and Q2 corresponds at least to Q3. Preferably, Q3 is selected such that an equilibrium yield Y of ≧90% to ≦100% and more preferably ≧92% to ≦99.99% is achieved.

In the process of the invention, the products, especially synthesis gas, are prepared in a reactor which is heated either by autothermal means or by means of available electrical energy. It is possible with preference to use methane together with water or CO₂ as reactants. The reverse water-gas shift reaction is a further option for preferential preparation of CO. For the execution of the reactions, especially at the exit of the reactor, the aim should be high temperatures of >>700° C., in order to maximize yields.

An autothermal reaction regime enables provision of the required energy input especially to very endothermic reactions such as dry reforming (+247 kJ/mol) or steam reforming (+206 kJ/mol). The autothermal reaction regime is effected here through the oxidation of preferably methane and/or hydrogen, or else portions of the products formed (e.g. CO). The oxidation is effected firstly at the reactor inlet, as a result of which the inlet temperature can be brought rapidly to a high level, and “cold spots” resulting from the endothermicity of the reactions are avoided. Additionally the gas is fed in through laterally along the reactor length, in order to reduce the fuel gas concentration in the inlet region and hence the maximum adiabatic temperature increase theoretically possible. In addition, the lateral feeding can bring the temperature level to values above the inlet temperature. This heating concept is coupled with the additional option of feeding in electrical energy, preferably in the middle of and at the end of the reactor. The coupling of the two heating mechanisms, autothermal and electrical energy input, allows the establishment of optimal temperature profiles along the reactor, for example a rising temperature ramp along the reactor length, which has a positive influence on the thermodynamics of the endothermic reactions. Thus, the reaction regime is optimized in terms of the CO/H₂ yield.

The feed of electrical energy may come, for example, from renewable sources. The increased development of renewable energies is causing a fluctuating energy supply on the power grid. In periods of favorable power prices, for the operation of reactors for preparation of synthesis gas (endothermic reactions), there is the possibility of efficient and economically viable operation exploiting renewable energies and simultaneously saving methane/hydrogen, which are then needed to a lesser extent for heating. In contrast, there are periods of high power prices in which the supply of electrical energy required for performance of the operations should be minimized. However, the proportion of renewable energy in the grid also determines the economic efficiency of the process. As will be described later, the process regime of the endothermic synthesis gas production can be configured in terms of energy demand such that economically and ecologically viable operating points can be established depending on the power price and the proportion of renewable energy in the power grid.

The energy is supplied within the reactor in the process described above by oxidation of a portion of the feed gas supplied, methane in the case of DRM or SMR and/or hydrogen in the case of RWGS, and/or by electrical heating. Both methods are usable for all the reactions mentioned. In the case of oxidation, a portion of the methane (in the case of DR and SMR) or hydrogen (in the case of RWGS) supplied is partially oxidized by oxygen which has been additionally introduced. The resultant heat of combustion is subsequently utilized both for the particular endothermic reaction and for further heating of the reaction gas. Especially at the reactor input, this is advisable in order to capture the endothermicity of the reaction and to avoid “cold spots”. This can likewise be utilized for bringing the reaction gas to a desired input and output temperature. By means of intermediate gas feeds, an energy input is additionally possible for the reaction and/or the heating of the reaction gas, and a temperature profile can be established, as a result of which higher CO/H₂ yields are achieved in thermochemically limited reforming processes. It is likewise possible through the side feed to reduce the fuel gas concentration in the inlet region and hence to reduce the adiabatic temperature increase theoretically possible. The addition of oxygen necessary may be either continuous or discontinuous. The addition of oxygen is effected within the upper explosion range and can be accomplished in the following forms: addition of pure oxygen, addition of air and/or in a mixture with one of the other species that occur in the reactor (CH₄, H₂, CO₂, H₂O, N₂). An oxygen/air mixture together with CO₂ and/or H₂O is the aim here.

With increasing conversion in the methane/hydrogen reaction, the heating method through oxidation of the reactor materials is increasingly ineffective. This problem is solved by the additional utilization of electrical heating segments in which the rest of the conversion can be effected. With the aid of the electrical heating, the inventive reactor concept, through which the energy required by the reaction is still supplied by means of the coupling with an electrical heating segment in the rear part of the reactor, enables additional yields of synthesis gas. The segmented incorporation of heating elements enables any desired temperature profile over the reactor length within the desired temperature range.

A further advantage of this reactor concept lies in the flexible switching of the heating methods from oxidation to electrical and/or running in alternating operation between strongly exothermic (DR, SMR) and weakly endothermic reactions (RWGS).

In the process of the invention, the same reactor is used for both reaction types (endothermic and exothermic), and so there is no need to switch the reactant streams between separate apparatuses. Instead, it is possible to gradually start up the other reaction in each case by continuously reducing the methane feed while simultaneously increasing the hydrogen feed to the reactor, and vice versa. A mixed form of the two reactions is therefore also permissible. Metered addition of water is likewise possible in this concept, so as to result in operation as a steam reformer (SMR, +206 kJ/mol) or a mixed form of the three abovementioned reactions. It is thus possible to set the degree of endothermicity as desired, and it is matched in operation to the boundary conditions relating to energy economics and the local situation.

In the endothermic mode of the reactor, CO₂ reacts with hydrocarbons, H₂O and/or H₂ to form CO (among other substances). The hydrocarbons involved for the endothermic and exothermic reactions are preferably alkanes, alkenes, alkynes, alkanols, alkenols and/or alkynols. Among the alkanes, methane is particularly suitable; among the alkanols, methanol and/or ethanol are preferred.

In exothermic mode, the reactants used are hydrocarbons, CO and/or hydrogen. They react with one another or with further reactants in the reactor.

As already mentioned, examples of endothermic reactions are:
dry reforming of methane (DR): CH₄+CO₂⇄2CO+2H₂
steam reforming of methane (SMR): CH₄+H₂O ⇄3H₂+CO
reverse water-gas shift reaction (RWGS): CO₂+H₂⇄CO+H₂O
   Examples of exothermic reactions are:
partial oxidation of methane (POX): CH₄+½O₂→CO+2H₂
Boudouard reaction: 2CO⇄C+CO₂
methane combustion (CMB): CH₄+2O₂→CO₂+2H₂O
CO oxidation: CO+½O₂→CO₂
hydrogen combustion: H₂+½O₂→H₂O
oxidative coupling of methane (OCM): 2CH₄+O₂→C₂H₄+2H₂O

The exothermic partial oxidation generates the thermal energy required and additionally produces synthesis gas. For example, it is thus possible to continue production in the same reactor at night or during windless parts of the day.

In addition, the combustion of hydrogen can be used as an alternative or additional heating method. It is possible either that the combustion of hydrogen is effected in the RWGS reaction by metered addition of O₂ to the reactant gas (ideally a locally distributed or lateral metered addition), or that hydrogen-rich residual gases (for example PSA offgas), as can be obtained in the purification of the synthesis gas, are recycled and combusted together with O₂, as a result of which the process gas is then heated.

One advantage of the oxidative mode is that soot deposits formed by dry reforming or steam reforming can be removed, and so the catalyst used can be regenerated. Moreover, it is possible to regenerate passivation layers of the heat conductor or of other metallic internals, in order to increase the service life.

In general, endothermic reactions are heated from the outside through the walls of the reaction tubes. This contrasts with autothermal reforming with addition of O₂. In the reactor operation described here, the endothermic reaction can be efficiently supplied internally with heat by electrical heating within the reactor (the undesirable alternative would be electrical heating via radiation through the reactor wall). This mode of reactor operation becomes economically viable especially when the oversupply resulting from the development of renewable energy sources can be utilized inexpensively.

The process of the invention envisages allowing the DR, SMR, RWGS and POX reactions to proceed in the same reactor. Mixed operation is explicitly envisaged. One of the advantages of this option is the gradual startup of the other reaction in each case, for example by continuously reducing the hydrocarbon supply while simultaneously increasing the methane supply, or by continuously increasing the hydrocarbon supply while simultaneously reducing the methane supply.

The present invention, including preferred embodiments, is elucidated in detail in conjunction with the drawings which follow, without being restricted thereto. The embodiments can be combined with one another as desired, unless the opposite is immediately apparent from the context.

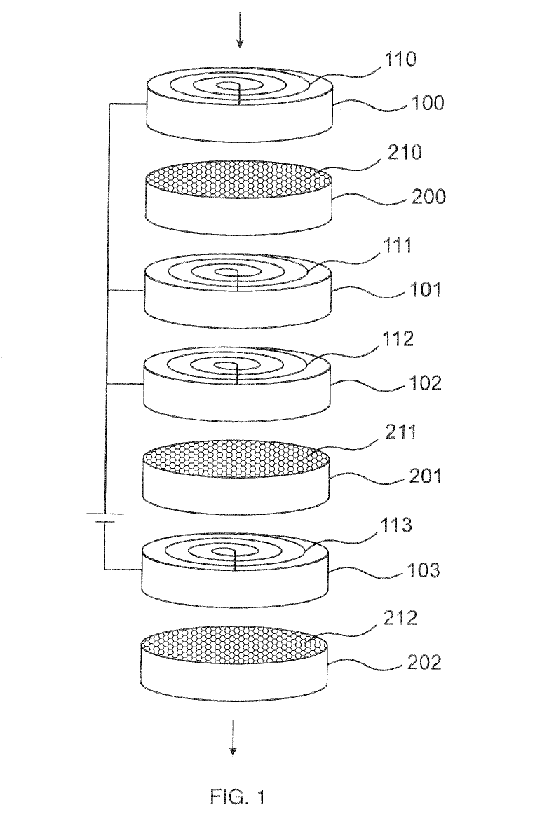

FIG. 1 shows a schematic view of a flow reactor in expanded form.

In one embodiment of the process of the invention, the endothermic reaction is selected from: dry reforming of methane, steam reforming of methane, reverse water-gas shift reaction, coal gasification and/or methane pyrolysis, and the exothermic reaction is selected from: partial oxidation of methane, autothermal reforming, Boudouard reaction, methane combustion, CO oxidation, hydrogen oxidation, oxidative coupling of methane and/or Sabatier methanization (CO₂ and CO to methane).

In a further embodiment of the process of the invention, the proportion of the amount of heat Q2 in the reactor increases in the downstream direction, viewed in flow direction of the fluid comprising reactants.

In a further embodiment of the process of the invention, said process further comprises the steps of:
determining a
   threshold S1 for the costs of the electrical energy available to the flow reactor and/or a
   threshold S2 for the relative proportion of electrical energy from renewable sources in the electrical energy available to the flow reactor; and
comparing
   the costs of the electrical energy available to the flow reactor with the threshold S1 and/or
   the relative proportion of electrical energy from renewable sources in the electrical energy available to the flow reactor with the threshold S2;
reducing the extent of the exothermic reaction and/or increasing the extent of the electrical heating of the reactor when the value is below the threshold S1 and/or the threshold S2 is exceeded; and
increasing the extent of the exothermic reaction and/or reducing the extent of the electrical heating of the reactor when the value is below the threshold S1 and/or the threshold S2 is exceeded.

In this variant for hybrid operation of synthesis gas production, a decision is made on the basis of one or more thresholds as to which mode of operation is to be chosen. The first threshold S1 relates to the electricity costs for the reactor, specifically the costs for electrical heating of the reactor by the heating elements in the heating levels. It is possible here to determine the level up to which the electrical heating is still economically viable.

The second threshold S2 relates to the relative proportion of electrical energy from renewable sources which is available for the reactor and also again specifically for the electrical heating of the reactor by the heating elements in the heating levels. The relative proportion is based here on the total amount of electrical energy in the electrical energy available to the flow reactor and may of course vary over the course of time. Examples of renewable sources from which electrical energy can be generated are wind energy, solar energy, geothermal energy, wave energy and hydroelectric power. The relative proportion can be determined from information given by the energy supplier. If, for example, in-house renewable energy sources such as solar plants or wind power plants are available on a site, this relative energy proportion too can be specified via performance monitoring.

In the same way as the threshold S1 can be understood, for example, as an upper price limit, the threshold S2 can be regarded as a requirement to utilize renewable energies to the greatest possible justifiable extent. For example, S2 may state that the reactor is to be electrically heated from a proportion of 5%, 10% or 20% or 30% of electrical energy from renewable sources.

A comparison of the target values with the actual values in the process may then arrive at the result that the electrical energy is available inexpensively and/or sufficient electrical energy is available from renewable sources. Then the flow reactor is operated in such a way that the exothermic reaction is conducted to a lesser extent and/or there is greater electrical heating.

If the comparison of target/actual values shows that electrical energy is too expensive and/or too much energy would have to be used from non-renewable sources, the extent of the exothermic reaction is increased and/or the extent of electrical heating is reduced.

In order to ensure that a sufficient amount of hydrogen is available even in prolonged RWGS phases, the system can be coupled to a water electrolysis unit for hydrogen production. The operating strategy of water electrolysis is likewise coupled here to the parameters of ‘power price’ and ‘proportion of renewable energy in the grid’. The overall system may therefore have at least one hydrogen storage means if required. The possibility of conducting a steam reforming or a mixed reforming, and therefore an increase in the hydrogen content in the synthesis gas compared to DR, results in a further degree of freedom in the operating strategy for preparation of hydrogen for pure RWGS phases.

In a further embodiment of the process of the invention, the flow reactor comprises:

a multitude of heating levels, viewed in flow direction of the fluid,
which are electrically heated by means of heating elements and
where the fluid can flow through the heating levels,
where a catalyst is arranged on at least one heating element and can be heated thereon,
where an intermediate level is additionally arranged at least once between two heating levels and
where the fluid can likewise flow through the intermediate level.

A fluid comprising reactants flows from the top downward through the flow reactor for use in accordance with the invention shown schematically in FIG. 1, as shown by the arrows in the drawing. The fluid may be in liquid or gaseous form and may be monophasic or polyphasic.

Preferably, in view of the possible reaction temperatures as well, the fluid is gaseous. It is conceivable either that the fluid comprises exclusively reactants and reaction products or else that inert components such as inert gases are additionally present in the fluid.

Viewed in flow direction of the fluid, the reactor has a multitude of (four in the present case) heating levels 100, 101, 102, 103, which are electrically heated by means of corresponding heating elements 110, 111, 112, 113. The fluid flows through the heating levels 100, 101, 102, 103 in the operation of the reactor, and the heating elements 110, 111, 112, 113 are contacted by the fluid.

A catalyst is arranged on at least one heating element 110, 111, 112, 113 and is heatable thereon. The catalyst may be connected directly or indirectly to the heating elements 110, 111, 112, 113, such that these heating elements constitute the catalyst support or a support for the catalyst support.

In the reactor, the supply of heat to the reaction is thus effected electrically, and it is not introduced from the outside by means of radiation through the walls of the reactor, but directly into the interior of the reaction space. Direct electrical heating of the catalyst is achieved.

For the heating elements 110, 111, 112, 113, preferably high-temperature conductor alloys such as FeCrAl alloys are used. As alternative to metallic materials, it is additionally also possible to use electrically conductive Si-based materials, more preferably SiC.

In the reactor, a preferably ceramic intermediate level 200, 201, 202 is additionally arranged at least once between two heating levels 100, 101, 102, 103, and the fluid likewise flows through the intermediate level(s) 200, 201, 202 in the operation of the reactor. This has the effect of homogenising the fluid flow. It is also possible that additional catalyst is present in one or more intermediate levels 200, 201, 202 or further insulation elements in the reactor. In that case, an adiabatic reaction can proceed. The intermediate levels can, if required, especially in reactions in which an oxygen supply is envisaged, function as a flame barrier.

In the case of use of FeCrAl high-temperature conductors, it is possible to exploit the fact that the material forms an Al₂O₃ protective layer as a result of the action of temperature in the presence of air/oxygen. This passivation layer can serve as a base layer for a washcoat, which functions as a catalytically active coating. Thus, direct resistance heating of the catalyst or supply of heat to the reaction is achieved directly via the catalytic structure. It is also possible, in the case of use of other high-temperature conductors, to form other protective layers, for example of Si—O—C systems.

The pressure in the reactor can be absorbed by means of a pressure-resistant steel jacket. Using suitable ceramic insulation materials, it is possible to achieve exposure of the pressure-bearing steel to temperatures of less than 200° C. and, where necessary, even less than 60° C. By means of appropriate devices, it is possible to ensure that there is no condensation of water on the steel jacket when the temperature goes below the dew point.

The electrical connections are shown only in very schematic form in FIG. 1. In the low-temperature region of the reactor, they can be conducted within an insulation to the ends of the reactor, or laterally out of the heating elements 110, 111, 112, 113, such that the actual electrical connections can be provided in the low-temperature region of the reactor. The electrical heating is effected with direct current or alternating current.

Through suitable shaping, an increase in the surface area can be achieved. It is possible that heating elements 110, 111, 112, 113 are arranged in the heating levels 100, 101, 102, 103, and these may be in spiral form, in meandering form, in grid form and/or in network form.

It is additionally possible that a different amount of and/or type of catalyst is present in at least one heating element 110, 111, 112, 113 than in the other heating elements 110, 111, 112, 113. Preferably, the heating elements 110, 111, 112, 113 are set up such that they can each be electrically heated independently.

The end result is that the individual heating levels can be controlled and regulated individually. In the inlet region of the reactor, if required, it is also possible to dispense with a catalyst in the heating levels, such that exclusively the heating and no reaction proceeds in the inlet region. This is especially advantageous with regard to the startup of the reactor. If the individual heating levels 100, 101, 102, 103 are different in terms of power input, catalyst loading and/or catalyst type, a temperature profile matched to the particular reaction can be achieved. With regard to use for endothermic equilibrium reactions, this temperature profile is, for example, a temperature profile which reaches the highest temperatures and hence the highest conversion at the reactor exit.

The intermediate levels 200, 201, 202 (which are ceramic, for example), or the contents thereof 210, 211, 212, comprise a material stable under the reaction conditions, for example a ceramic foam. They serve to mechanically support the heating levels 100, 101, 102, 103, and to mix and distribute the gas stream. At the same time, electrical insulation between two heating levels is possible in this way. It is preferable that the material of the contents 210, 211, 212 of an intermediate level 200, 201, 202 comprises oxides, carbides, nitrides, phosphides and/or borides of aluminum, silicon and/or zirconium. One example of these is SiC. Also preferred is cordierite.

The intermediate level 200, 201, 202 may, for example, comprise a loose bed of solid bodies. These solid bodies themselves may be porous or solid, such that the fluid flows through gaps between the solid bodies. It is preferable that the material of the solid bodies comprises oxides, carbides, nitrides, phosphides and/or borides of aluminum, silicon and/or zirconium. One example of these is SiC. Also preferred is cordierite.

It is likewise possible that the intermediate level 200, 201, 202 comprises a one-piece porous solid body. In this case, the fluid flows through the intermediate level via the pores of the solid body.

This is shown in FIG. 1. Preference is given to honeycomb monoliths, as used, for example, in the treatment of exhaust gas from internal combustion engines.

A further conceivable option is that one or more of the intermediate levels are empty spaces.

With regard to the construction dimensions, it is preferable that the average length of a heating level 100, 101, 102, 103, viewed in flow direction of the fluid, and the average length of an intermediate level 200, 201, 202, viewed in flow direction of the fluid, are in a ratio of ≧0.01:1 to ≦100:1 to one another. Even more advantageous ratios are from ≧0.1:1 to ≦10:1 or 0.5:1 to ≦5:1

Suitable catalysts may be selected, for example, from the group comprising:

(I) a mixed metal oxide of the formula A_{(1-w-x)}A′_{w}A″ₓB_{(1-y-z)}B′_{y}B″_{z}O_{3-delta} where:
A, A′ and A″ are each independently selected from the group of: Mg, Ca, Sr, Ba, Li, Na, K, Rb, Cs, Sn, Sc, Y, La, Ce, Pr, Nd, Pm, Sm, Eu, Gd, Tb, Dy, Ho, Er, Tm, Yb, Tl, Lu, Ni, Co, Pb, Bi and/or Cd;
B, B′ and B″ are each independently selected from the group of: Cr, Mn, Fe, Bi, Cd, Co, Cu, Ni, Sn, Al, Ga, Sc, Ti, V, Nb, Ta, Mo, Pb, Hf, Zr, Tb, W, Gd, Yb, Mg, Li, Na, K, Ce and/or Zn; and
0≦w≦0.5; 0≦x≦0.5; 0≦y≦0.5; 0≦z≦0.5 and −1≦delta≦1;
(II) a mixed metal oxide of the formula A_{(1-w-x)}A′_{w}A″ₓB_{(1-y-z)}B′_{y}B″_{z}O_{3-delta} where:
A, A′ and A″ are each independently selected from the group of: Mg, Ca, Sr, Ba, Li, Na, K, Rb, Cs, Sn, Sc, Y, La, Ce, Pr, Nd, Sm, Eu, Gd, Tb, Dy, Ho, Er, Tm, Yb, Tl, Lu, Ni, Co, Pb and/or Cd;
B is selected from the group of: Cr, Mn, Fe, Bi, Cd, Co, Cu, Ni, Sn, Al, Ga, Sc, Ti, V, Nb, Ta, Mo, Pb, Hf, Zr, Tb, W, Gd, Yb, Bi, Mg, Cd, Zn, Re, Ru, Rh, Pd, Os, Ir and/or Pt;
B′ is selected from the group of: Re, Ru, Rh, Pd, Os, Ir and/or Pt;
B″ is selected from the group of: Cr, Mn, Fe, Bi, Cd, Co, Cu, Ni, Sn, Al, Ga, Sc, Ti, V, Nb, Ta, Mo, Pb, Hf, Zr, Tb, W, Gd, Yb, Bi, Mg, Cd and/or Zn;
and
0≦w≦0.5; 0≦x≦0.5; 0≦y≦0.5; 0≦z≦0.5 and −1≦delta≦1;
(III) a mixture of at least two different metals M1 and M2 on a support comprising an oxide of Al, Ce and/or Zr doped with a metal M3;
where:
M1 and M2 are each independently selected from the group of: Re, Ru, Rh, Ir, Os, Pd and/or Pt; and
M3 is selected from the group of: Sc, Y, La, Ce, Pr, Nd, Sm, Eu, Gd, Tb, Dy, Ho, Er, Tm, Yb and/or Lu;
(IV) a mixed metal oxide of the formula LOₓ(M_{(y/z)}Al_{(2-y/z)}O₃)_{z}; where:
L is selected from the group of: Na, K, Rb, Cs, Mg, Ca, Sr, Ba, Sc, Y, Sn, Pb, Pd, Mn, In, Tl, La, Ce, Pr, Nd, Sm, Eu, Gd, Tb, Dy, Ho, Er, Tm, Yb and/or Lu;
M is selected from the group of: Ti, Zr, Hf, V, Nb, Ta, Cr, Mo, W, Mn, Re, Fe, Ru, Os, Co, Rh, Ir, Ni, Pd, Pt, Zn, Cu, Ag and/or Au;
1<x≦2;
0<y≦12; and
4≦z≦9;
(V) a mixed metal oxide of the formula LO(Al₂O₃)_{z};
where:
L is selected from the group of: Na, K, Rb, Cs, Mg, Ca, Sr, Ba, Sc, Y, Sn, Pb, Mn, In, Tl, La, Ce, Pr, Nd, Sm, Eu, Gd, Tb, Dy, Ho, Er, Tm, Yb and/or Lu; and
4≦z≦9;
(VI) an oxidic catalyst comprising Ni and Ru;
(VII) a metal M1 and/or at least two different metals M1 and M2 on and/or in a support, the support being a carbide, oxycarbide, carbonitride, nitride, boride, silicide, germanide and/or selenide of the metals A and/or B;
where:
M1 and M2 are each independently selected from the group of: Cr, Mn, Fe, Co, Ni, Re, Ru, Rh, Ir, Os, Pd, Pt, Zn, Cu, La, Ce, Pr, Nd, Sm, Eu, Gd, Tb, Dy, Ho, Er, Tm, Yb, and/or Lu;
A and B are each independently selected from the group of: Be, Mg, Ca, Sc, Ti, V, Cr, Mn, Fe, Co, Ni, Y, Zr, Nb, Mo, Hf, Ta, W, La, Ce, Pr, Nd, Sm, Eu, Gd, Tb, Dy, Ho, Er, Tm, Yb, and/or Lu;
(VIII) a catalyst comprising Ni, Co, Fe, Cr, Mn, Zn, Al, Rh, Ru, Pt and/or Pd;
and/or
reaction products of (I), (H), (III), (IV), (V), (VI), (VII) and/or (VIII) in the presence of carbon dioxide, hydrogen, carbon monoxide and/or water at a temperature of ≧700° C.

The term “reaction products” includes the catalyst phases present under the reaction conditions.

Preference is given to:
(I) LaNiO₃ and/or LaNi_{0.7-0.9}Fe_{0.1-0.3}O₃ (especially LaNi_{0.8}Fe_{0.2}O₃)
(II) LaNi_{0.9-0.99}Ru_{0.01-0.1}O₃ and/or LaNi_{0.9-0.99}Rh_{0.01-0.1}O₃ (especially LaNi_{0.95}Ru_{0.05}O₃ and/or LaNi_{0.95}Rh_{0.05}O₃).
(III) Pt—Rh on Ce—Zr—Al oxide, Pt—Ru and/or Rh—Ru on Ce—Zr—Al oxide
(IV) BaNiAl₁₁O₁₉, CaNiAl₁₁O₁₉, BaNi_{0.975}Ru_{0.025}Al₁₁O₁₉, BaNi_{0.95}Ru_{0.05}Al₁₁O₁₉, BaNi_{0.92}Ru_{0.08}Al₁₁O₁₉, BaNi_{0.84}Pt_{0.16}Al₁₁O₁₉ and/or BaRu_{0.05}Al_{11.95}O₁₉
(V) BaAl₁₂O₁₉, SrAl₁₂O₁₉ and/or CaAl₁₂O₁₉
(VI) Ni and Ru on Ce—Zr—Al oxide, or on an oxide of the perovskite class and/or on an oxide of the hexaaluminate class
(VII) Cr, Mn, Fe, Co, Ni, Re, Ru, Rh, Ir, Os, Pd, Pt, Zn, Cu, La, Ce, Pr, Nd, Sm, Eu, Gd, Tb, Dy, Ho, Er, Tm, Yb, and/or Lu on Mo₂C and/or WC.

In the process of the invention, in the reactor provided, at least one of the heating elements 110, 111, 112, 113 is electrically heated. This can, but need not, precede the flow of a fluid comprising reactants through the flow reactor with at least partial reaction of the reactants in the fluid.

The reactor may be constructed in modular form. A module may comprise, for example, a heating level, an insulation level, the electrical contact-forming device and the appropriate further insulation materials and thermal insulators.

As already mentioned in connection with the reactor, it is advantageous when the individual heating elements 110, 111, 112, 113 are each operated with a different heating power.

With regard to the temperature, it is preferable that the reaction temperature in the reactor, at least in some places, is ≧700° C. to ≦1300° C. More preferred ranges are ≧800° C. to ≦1200° C. and ≧900° C. to ≦1100° C.

The average (mean) contact time of the fluid with a heating element 110, 111, 112, 113 may, for example, be ≧0.01 second to ≦1 second and/or the average contact time of the fluid with an intermediate level 110, 111, 112, 113 may, for example, be ≧0.001 second to ≦5 seconds. Preferred contact times are ≧0.005 to ≦1 second, more preferably ≧0.01 to ≦0.9 second.

The reaction can be conducted at a pressure of ≧1 bar to ≦200 bar. Preferably, the pressure is ≧2 bar to ≦50 bar, more preferably ≧10 bar to ≦30 bar.

In a further embodiment of the process of the invention:
a desired H₂/CO ratio in the synthesis gas is fixed and
the reaction of carbon dioxide with hydrocarbons, water and/or hydrogen is conducted in the flow reactor, the product formed being at least carbon monoxide, with electrical heating by means of one or more heating elements (110, 111, 112, 113) when the ratio goes below the desired ratio of H₂/CO; and
the reaction of hydrocarbons with oxygen is conducted in the flow reactor, the products formed being at least carbon monoxide and hydrogen, when the desired ratio of H₂/CO is exceeded;
   with the following exception: a changeover from the reaction of carbon dioxide with hydrocarbons, forming at least carbon monoxide as product, to the reaction of hydrocarbons with oxygen, forming at least carbon monoxide and hydrogen as products, takes place when the ratio goes below the desired ratio of H₂/CO, and vice versa.

In the specific example, the H₂/CO ratio changes from 1:1 to 2:1 at the changeover from CO₂ reforming to POX. Modifications by the addition of H₂O or CO₂ in the SMR are additionally possible. In the changeover from dry reforming to POX, in contrast, the H₂/CO ratio changes from 1:1 to 2:1.

In a further embodiment, the main target product may be CO or H₂. The parameter S1 is undershot and/or the parameter S2 is exceeded. As a result of this, endothermic operation is preferred, i.e. steam reforming or dry reforming, in which case CO₂ is additionally used as C1 source, which is manifested in a saving of methane. As a result of the dry reforming, two moles of CO and two moles of H₂ are obtained per mole of methane. The reactant ratio of CO₂/CH₄ is ≧1.25. The CO₂ present in the product gas is removed in subsequent process steps and recycled into the reactor. As soon as the parameter S1 is exceeded and/or the parameter S2 is undershot, the mode of operation is switched from endothermic operation to exothermic operation. In this case, methane is supplied to the reactor together with O₂. CO₂ may continue to be metered in during the switchover phase and be used as a kind of inert component until the POX reaction has been stabilized and a new steady state is attained. The CO₂ removed in the subsequent steps can be stored intermediately, in order to be used as reactant in the startup of the endothermic reaction. In the changeover of operating mode to partial oxidation, the reactant streams or the throughput of methane and oxygen are adjusted such that a constant amount of CO or amount of H₂ is available for subsequent processes.

In a further preferred embodiment, the target product is CO. The parameter S1 is undershot and/or the parameter S2 is exceeded. As a result of this, endothermic operation is preferred, i.e. the performance of the rWGS reaction, in which case CO₂ is used as C1 source. As a result of the rWGS reaction, one mole of CO and one mole of water are present per mole of CO₂. The reactant ratio of H₂/CO₂ is ≧1.25. The CO₂ present in the prior gas is removed in subsequent process steps and recycled into the reactor. As soon as the parameter S1 is exceeded and/or the parameter S2 is undershot, the mode of operation is switched from endothermic operation to exothermic operation. In this case, methane is supplied to the reactor together with O₂. CO₂ may continue to be metered in during the switchover phase and be used as a kind of inert component until the POX reaction has been stabilized and a new steady state is attained. A portion of the hydrogen prepared during the POX operation can be stored intermediately and used for the operation of the rWGS reaction. In the changeover of operating mode to partial oxidation, the reactant streams or the throughput of methane and oxygen are adjusted such that a constant amount of CO is available for subsequent processes.

In a further embodiment of the process, it is possible to react flexibly to the methane price. This is then compared with the particular power price. In this case, the saving of methane in the performance of the electrically heated CO₂ reforming, which uses CO₂ as C1 source, is weighed against the costs of electrical heating.

In a further embodiment, the changeover to the exothermic mode of operation is effected in order to react to soot formation during endothermic operation. Operation with O₂ can be used to regenerate passivation layers within the reactor.

As well as exothermic operation for provision of a synthesis gas, the electrical heating elements in the region of the reactor inlet can be used for the startup operation. Thus, rapid heating of the reactant stream is possible, which reduces coking in the performance of the endothermic reforming reaction and enables locally defined light-off of the reaction in the performance of POX and hence enables safer reactor operation.

The present invention likewise relates to a control unit set up for the control of the process of the invention. This control unit may also be distributed over several modules which communicate with one another, or may then comprise these modules. The control unit may contain a volatile and/or nonvolatile memory which contains machine-executable commands in connection with the process of the invention. More particularly, these may be machine-executable commands for registering the thresholds, for comparing the thresholds with the current conditions and for control of control valves and compressors for gaseous reactants.

1. A process for preparing gas mixtures comprising carbon monoxide and hydrogen, comprising the steps of:
providing a flow reactor set up for reaction of a fluid comprising reactants,
where the reactor comprises at least one heating level (100, 101, 102, 103) which is electrically heated by means of one or more heating elements (110, 111, 112, 113),
where the fluid can flow through the heating level (100, 101, 102, 103) and
where a catalyst is arranged on at least one heating element (110, 111, 112, 113) and can be heated thereon;
endothermic reaction of carbon dioxide with hydrocarbons, water and/or hydrogen in the flow reactor, forming at least carbon monoxide as product, with electrical heating by one or more heating elements (110, 111, 112, 113); and simultaneously
exothermic reaction of hydrocarbons, carbon monoxide and/or hydrogen as reactants in the flow reactor;
wherein the exothermic reaction releases an amount of heat Q1, the electrical heating of the reactor releases an amount of heat Q2 and the exothermic reaction and the electrical heating of the reactor are operated such that the sum total of Q1 and Q2 is greater than or equal to the amount of heat Q3 required for an equilibrium yield Y of the endothermic reaction of ≧90%.

2. The process as claimed in claim 1, wherein the endothermic reaction is selected from: dry reforming of methane, steam reforming of methane, reverse water-gas shift reaction, coal gasification and/or methane pyrolysis, and the exothermic reaction is selected from: partial oxidation of methane, autothermal reforming, Boudouard reaction, methane combustion, CO oxidation, hydrogen oxidation, oxidative coupling of methane and/or Sabatier methanization.

3. The process as claimed in claim 1, wherein the proportion of the amount of heat Q2 in the reactor increases in the downstream direction, viewed in flow direction of the fluid comprising reactants.

4. The process as claimed in claim 1, further comprising the steps of:
determining a
threshold S1 for the costs of the electrical energy available to the flow reactor and/or a
threshold S2 for the relative proportion of electrical energy from renewable sources in the electrical energy available to the flow reactor; and
comparing
the costs of the electrical energy available to the flow reactor with the threshold S1 and/or
the relative proportion of electrical energy from renewable sources in the electrical energy available to the flow reactor with the threshold S2;
reducing the extent of the exothermic reaction and/or increasing the extent of the electrical heating of the reactor when the value is below the threshold S1 and/or the threshold S2 is exceeded; and
increasing the extent of the exothermic reaction and/or reducing the extent of the electrical heating of the reactor when the value is below the threshold S1 and/or the threshold S2 is exceeded.

5. The process as claimed in claim 1, wherein the flow reactor comprises:
a multitude of heating levels (100, 101, 102, 103), viewed in flow direction of the fluid,
which are electrically heated by means of heating elements (110, 111, 112, 113) and
where the fluid can flow through the heating levels (100, 101, 102, 103),
where a catalyst is arranged on at least one heating element (100, 101, 102, 103) and can be heated thereon,
where a ceramic intermediate level (200, 201, 202) (which is preferably borne by a ceramic or metallic support structure/level) is additionally arranged at least once between two heating levels (100, 101, 102, 103) and
where the fluid can likewise flow through the intermediate level (200, 201, 202).

6. The process as claimed in claim 5, wherein heating elements (110, 111, 112, 113) arranged within the heating levels (100, 101, 102, 103) are in spiral form, in meandering form, in grid form and/or in network form.

7. The process as claimed in claim 5, wherein a different amount of and/or type of catalyst is present in at least one heating element (110, 111, 112, 113) than in the other heating elements (110, 111, 112, 113).

8. The process as claimed in claim 5, wherein the heating elements (110, 111, 112, 113) are set up such that they can each be electrically heated independently.

9. The process as claimed in claim 5, wherein the material of the contents (210, 211, 212) of an intermediate level (200, 201, 202) comprises oxides, carbides, nitrides, phosphides and/or borides of aluminum, silicon and/or zirconium.

10. The process as claimed in claim 5, wherein the average length of a heating level (100, 101, 102, 103), viewed in flow direction of the fluid, and the average length of an intermediate level (200, 201, 202), viewed in flow direction of the fluid, are in a ratio of ≧0.01:1 to ≦100:1 to one another.

11. The process as claimed in claim 1, wherein the catalyst is selected from the group comprising:
(I) a mixed metal oxide of the formula A_{(1-w-x)}A′_{w}A″ₓB_{(1-y-z)}B′_{y}B″_{z}O_{3-delta}
where:
A, A′ and A″ are each independently selected from the group of: Mg, Ca, Sr, Ba, Li, Na, K, Rb, Cs, Sn, Sc, Y, La, Ce, Pr, Nd, Pm, Sm, Eu, Gd, Tb, Dy, Ho, Er, Tm, Yb, Tl, Lu, Ni, Co, Pb, Bi and/or Cd;
B, B′ and B″ are each independently selected from the group of: Cr, Mn, Fe, Bi, Cd, Co, Cu, Ni, Sn, Al, Ga, Sc, Ti, V, Nb, Ta, Mo, Pb, Hf, Zr, Tb, W, Gd, Yb, Mg, Li, Na, K, Ce and/or Zn; and
0≦w≦0.5; 0≦x≦0.5; 0≦y≦0.5; 0≦z≦0.5 and −1≦delta≦1;
(II) a mixed metal oxide of the formula A_{(1-w-x)}A′_{w}A″ₓB_{(1-y-z)}B′_{y}B″_{z}O_{3-delta} where:
A, A′ and A″ are each independently selected from the group of: Mg, Ca, Sr, Ba, Li, Na, K, Rb, Cs, Sn, Sc, Y, La, Ce, Pr, Nd, Sm, Eu, Gd, Tb, Dy, Ho, Er, Tm, Yb, Tl, Lu, Ni, Co, Pb and/or Cd;
B is selected from the group of: Cr, Mn, Fe, Bi, Cd, Co, Cu, Ni, Sn, Al, Ga, Sc, Ti, V, Nb, Ta, Mo, Pb, Hf, Zr, Tb, W, Gd, Yb, Bi, Mg, Cd, Zn, Re, Ru, Rh, Pd, Os, Ir and/or Pt;
B′ is selected from the group of: Re, Ru, Rh, Pd, Os, Ir and/or Pt;
B″ is selected from the group of: Cr, Mn, Fe, Bi, Cd, Co, Cu, Ni, Sn, Al, Ga, Sc, Ti, V, Nb, Ta, Mo, Pb, Hf, Zr, Tb, W, Gd, Yb, Bi, Mg, Cd and/or Zn;
and
0≦w≦0.5; 0≦x≦0.5; 0≦y≦0.5; 0≦z≦0.5 and −1≦delta≦1;
(III) a mixture of at least two different metals M1 and M2 on a support comprising an oxide of Al, Ce and/or Zr doped with a metal M3;
where:
M1 and M2 are each independently selected from the group of: Re, Ru, Rh, Ir, Os, Pd and/or Pt; and
M3 is selected from the group of: Sc, Y, La, Ce, Pr, Nd, Sm, Eu, Gd, Tb, Dy, Ho, Er, Tm, Yb and/or Lu;
(IV) a mixed metal oxide of the formula LOₓ(M_{(y/z)}Al_{(2-y/z)}O₃)_{z}; where:
L is selected from the group of: Na, K, Rb, Cs, Mg, Ca, Sr, Ba, Sc, Y, Sn, Pb, Pd, Mn, In, Tl, La, Ce, Pr, Nd, Sm, Eu, Gd, Tb, Dy, Ho, Er, Tm, Yb and/or Lu;
M is selected from the group of: Ti, Zr, Hf, V, Nb, Ta, Cr, Mo, W, Mn, Re, Fe, Ru, Os, Co, Rh, Ir, Ni, Pd, Pt, Zn, Cu, Ag and/or Au;
1<x≦2;
0<y≦12; and
4≦z≦9;
(V) a mixed metal oxide of the formula LO(Al₂O₃)_{z};
where:
L is selected from the group of: Na, K, Rb, Cs, Mg, Ca, Sr, Ba, Sc, Y, Sn, Pb, Mn, In, Tl, La, Ce, Pr, Nd, Sm, Eu, Gd, Tb, Dy, Ho, Er, Tm, Yb and/or Lu; and
4≦z≦9;
(VI) an oxidic catalyst comprising Ni and Ru;
(VII) a metal M1 and/or at least two different metals M1 and M2 on and/or in a support, the support being a carbide, oxycarbide, carbonitride, nitride, boride, silicide, germanide and/or selenide of the metals A and/or B;
where:
M1 and M2 are each independently selected from the group of: Cr, Mn, Fe, Co, Ni, Re, Ru, Rh, Ir, Os, Pd, Pt, Zn, Cu, La, Ce, Pr, Nd, Sm, Eu, Gd, Tb, Dy, Ho, Er, Tm, Yb, and/or Lu;
A and B are each independently selected from the group of: Be, Mg, Ca, Sc, Ti, V, Cr, Mn, Fe, Co, Ni, Y, Zr, Nb, Mo, Hf, Ta, W, La, Ce, Pr, Nd, Sm, Eu, Gd, Tb, Dy, Ho, Er, Tm, Yb, and/or Lu;
(VIII) a catalyst comprising Ni, Co, Fe, Cr, Mn, Zn, Al, Rh, Ru, Pt and/or Pd;
and/or
reaction products of (I), (II), (III), (IV), (V), (VI), (VII) and/or (VIII) in the presence of carbon dioxide, hydrogen, carbon monoxide and/or water at a temperature of ≧700° C.

12. The process as claimed in claim 5, wherein the individual heating elements (110, 111, 112, 113) are each operated with a different heating power.

13. The process as claimed in claim 1, wherein the reaction temperature in the reactor, at least in places, is ≧700° C. to ≦1300° C.

14. The process as claimed in claim 5, wherein the average contact time of the fluid with a heating element (110, 111, 112, 113) is ≧0.001 second to ≦1 second and/or the average contact time of the fluid with an intermediate level (110, 111, 112, 113) is ≧0.001 second to ≦5 seconds.

15. The process as claimed in claim 1, wherein the selected reaction is conducted at a pressure of ≧1 bar to ≦200 bar.
